(19) United States
(12) Patent Application Publication
(10) Pub. No.: US 2013/0169105 A1
(43) Pub. Date: Jul. 4, 2013

(54) STATOR STRUCTURE OF MOTOR

(71) Applicant: Fang-Fu CHANG, Taipei City (TW)

(72) Inventor: Fang-Fu CHANG, Taipei City (TW)

(21) Appl. No.: 13/343,445

(22) Filed: Jan. 4, 2012

(51) Int. Cl. H02K 1/16

(52) U.S. Cl. 310/216.072

(57) ABSTRACT

A stator structure of motor includes at least an outer ring part having a plurality of containing slots, a plurality of salient ribs having a length “d”, a plurality of first slot legs having a first width “W1” and forming a first slot opening on both sides of the salient ribs with the slot wall, and a plurality of second slot legs having a second width “W2” and forming a second slot opening on both sides of the salient ribs with the slot wall. By making use of the two slot legs, the windings with appropriate number of wire-winding cycle form alternately disposed structure of unsymmetrical-width type to achieve the objective of fully utilizing the area of the slot opening making the winding is capable of generating rotational magnetic field with relatively better roundness, improving the efficiency of the electrical machine, and saving the material for the stator.

### BACKGROUND OF THE INVENTION

1. Field of the Invention

The invention relates to a stator structure of motor, and more particularly, to a stator structure of motor that is capable of generating a rotating magnetic field with better roundness, improving the efficiency of the electric machine, and saving material for the stator.

2. Description of the Prior Art

FIG. 1 is a cross-sectional view of the stator structure of the motor of the prior art. As shown in FIG. 1, the motor's rotor-and-stator structure (1) includes an outer ring part (11), a rotor (14), a plurality of salient ribs (12), and a plurality of slot legs (13).

The outer ring part (11) has a plurality of containing slots (111). The containing slots (111) and salient ribs (12) are alternately arranged in a circular pattern while the rotor (14) is positioned in the shaft center portion.

Each of the salient rib (12) is extended from the slot wall of the outer ring part (11) toward the shaft center portion with a length “d” to protrude through the slot wall and with a slot leg (13) that is formed by extending further. A slot opening (131) is formed by enclosing the slot wall, two adjacent salient ribs (12) and two adjacent slot legs (13) having a width “W”. The conducting wire is wound around the salient rib (12) to form the stator structure of motor.

As the current passes through the power source wire wound around the salient rib (12) making the salient ribs (12) generate magnetic force and consequently generate attraction and repulsion actions, the motor's rotor-and-stator structure of the prior art is capable of making the rotor (14) rotate.

However, the demerit of the motor of the prior art is that the coil having the slot leg (13) with fixed width “W” wound around to generate magnetic force with the stator is unable to output relatively larger torque unless the number of wire-winding cycle to wind around the stator increases tremendously. Accordingly, the size of the structure of the stator will be increased and consequently the size of the motor will also be increased.

To resolve the above-mentioned problems, it becomes necessary for the industry to improve the design of the stator structure of motor to increase motor's torque under the premise without increasing the size of the motor. This is the origin to have the present invention,

### SUMMARY OF THE INVENTION

In light of the above-mentioned disadvantages of the prior art, the invention provides “a stator structure of motor” that is capable of overcoming the shortcomings of the prior art, satisfying the requirements of the industry, as well as improving the competitiveness in the market. It aims to ameliorate at least some of the disadvantages of the prior art or to provide a useful alternative.

The primary objective of the invention is to provide “a stator structure of motor” to design different size of a first slot leg and a second slot leg to make the first slot leg and the second slot leg generate different magnitude of magnetic force and form different size of slot opening to wind coil having different number of wire-winding cycle to further generate a relatively larger torque for rotating the rotor of the motor.

To achieve the above-mentioned objectives, the invention provides a stator structure of motor that includes at least an outer ring part having a plurality of containing slots, a plurality of salient ribs having a length “d”, a plurality of first slot legs having a first width “W1” and forming a first slot opening on both sides of the salient ribs with the slot wall, and a plurality of second slot legs having a second width “W2” and forming a second slot opening on both sides of the salient ribs with the slot wall. By making use of the two slot legs, the windings with appropriate number of wire-winding cycle forms alternately disposed structure of unsymmetrical-width type to achieve the objective of fully utilizing the area of the slot opening making the winding is capable of generating rotational magnetic field with relatively better roundness, improving the efficiency of the electrical machine, and saving the material of the stator.

The accomplishment of the above-mentioned objectives of the invention will become apparent from the following description and its accompanied drawings of which:

### BRIEF DESCRIPTION OF THE DRAWINGS

FIG. 1 is a cross-sectional view of the stator structure of the motor of the prior art;

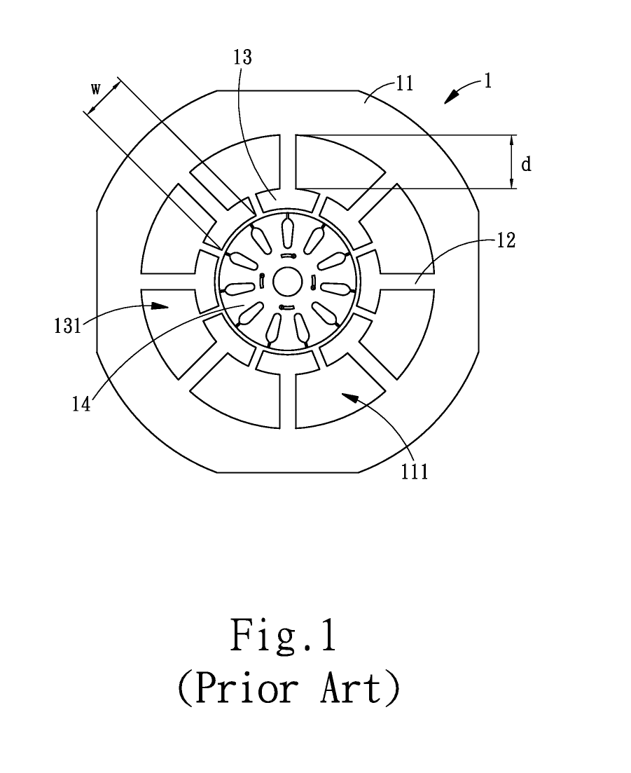

FIG. 2A is a cross-sectional view of the stator structure of the motor of a preferred embodiment of the invention;

FIG. 2B is a cross-sectional view of the coil winding of stator structure of the motor of a preferred embodiment of the invention.

### DETAILED DESCRIPTION OF THE PREFERRED EMBODIMENT

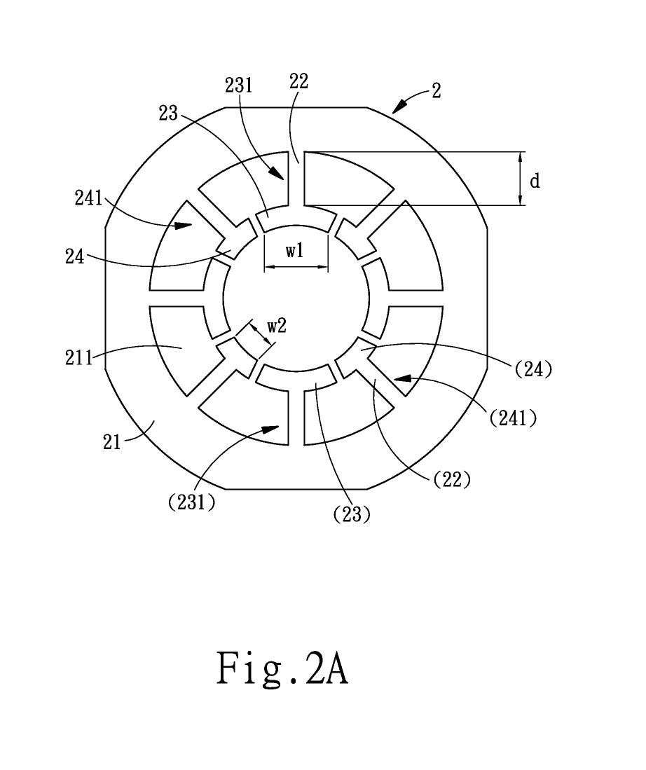

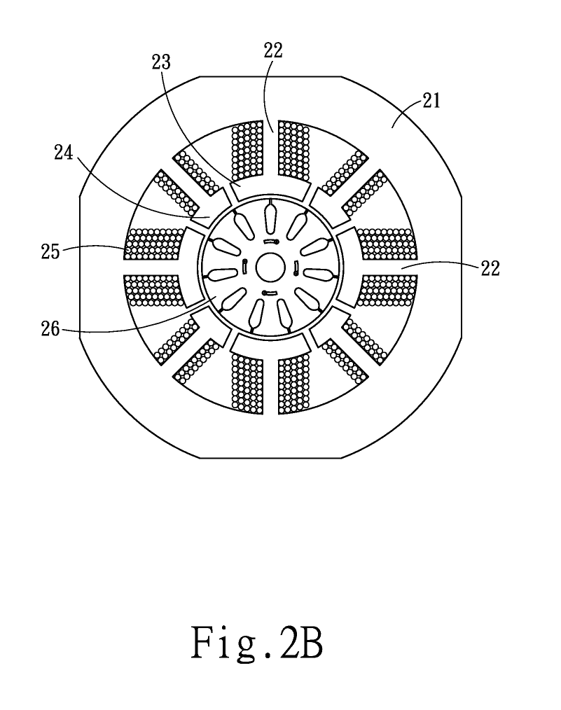

FIG. 2A is a cross-sectional view of the stator structure of the motor of a preferred embodiment of the invention while FIG. 2B is a cross-sectional view of the coil winding of stator structure of the motor of a preferred embodiment of the invention. As shown in FIG. 2A and FIG. 2B, the stator structure of motor (2) of the invention includes at least an outer ring part (21), a plurality of salient ribs (22), a plurality of first slot legs (23), a plurality of second slot legs (24), and a winding (25). The outer ring part (21) has a plurality of containing slots (211) that are disposed around a shaft center portion in circular shape for containing a rotor (26) (as shown in FIG. 2B). One end of each of the salient ribs (22) having a length “d” is formed by having one end necked-shrunk and extended from the slot wall of the containing slots (211) while the other end is extended toward the shaft center portion to form the first slot legs (23) and the second slot legs (24).

Each of the salient ribs (22) extended between the first slot legs (23) and both sides of the slot walls forms a first slot opening (231). Moreover, each of the first slot legs (23) has a first width “W1”.

Each of the salient ribs (22) extended between second slot legs (24) and both sides of the slot walls forms a second slot opening (241). Moreover, each of the second slot legs (24) has a second width “W2”.

The winding (25) being wound by conductive wire is a coil wound around the salient ribs (22) in accordance with each of the first width “W1” of the first slot legs (23) and each of the second width “W2” of the second slot legs (24). Moreover, as shown in FIG. 2B, between the first slot legs (23) and the slot wall as well as between the second slot legs (24) and the slot wall, the windings (25) is capable of forming a winding structure with different number of wire-winding cycle by alternately disposing in an unsymmetrical manner.

As the current passes through the winding (25), the coil wound around the salient ribs (22) generates electromagnetic effect causing the salient ribs (22) possess magnetism. In addition, the fact that the magnitude of the first width “W1” of the first slot legs (23) is greater than the magnitude of the second width “W2” of the second slot legs (24) makes the size of the first slot opening (231) greater than the size of the second slot opening (241) causing the volume for containing the winding (25) of the first slot opening (231) greater the volume for containing the winding (25) of the second slot opening (241), thereby the first slot opening (231) generates relatively larger magnetic force as comparing with the second slot opening (241). Consequently, comparing with the second slot leg (24), the first slot leg (23) possesses relatively larger attractive or repulsive force. As a result, the stator structure of motor of the invention is capable of achieving the objective of increasing the output torque.

As a conclusion, the design of the arrangement of unsymmetrical width of slot legs having the first slot legs (23) alternate with the second slot legs (24) making the attractive or repulsive forces of the first slot legs (23) greater that those of the second slot legs (24) makes the stator structure of motor of the invention generates relatively larger torque. As a result, the disadvantages of being relatively larger volume and relatively smaller torque of the motor of the prior art have been improved.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A stator structure of motor, comprising at least:
an outer ring part having a plurality of containing slots;
a plurality of salient ribs, having a length “d”, formed by extending from the slot wall of the containing slots is formed by having one end necked-shrunk and extended from the slot wall of the containing slots of the outer ring part while the other end is extended toward the shaft center portion to form a first slot leg or a second slot leg:
the plurality of first slot legs having a first width “W1” where a first slot opening is formed on both sides of the salient ribs that is formed by extending between the first slot legs and the slot wall; and
the plurality of second slot legs having a second width “W2” where a second slot opening is formed on both sides of the salient ribs that is formed by extending between the second slot legs and the slot wall;
wherein, by making use of the first width “W1” of the first slot legs and the second width “W2” of the second slot legs to wind around the salient ribs, the windings with appropriate number of wire-winding cycle forms alternately disposed structure of unsymmetrical-width type.

2. The stator structure of motor as claimed in claim 1, wherein the containing slots form in a circular shape by substantially disposing around the shape center portion in circumferential arrangement.

3. The stator structure of motor as claimed in claim 1, wherein the winding is wound around the salient rib.

4. The stator structure of motor as claimed in claim 1, wherein the dimension of the first width “W1” of the first slot legs is greater than the dimension of the second width “W2” of the second slot legs.
